(19) United States
(12) Patent Application Publication
(10) Pub. No.: US 2013/0052954 A1
(43) Pub. Date: Feb. 28, 2013

(54) DATA TRANSFER BETWEEN MOBILE COMPUTING DEVICES

(71) Applicant: Phani Bhushan Avadhanam, San Diego, CA (US)

(72) Inventor: Phani Bhushan Avadhanam, San Diego, CA (US)

(73) Assignee: QUALCOMM INNOVATION CENTER, INC., San Diego, CA (US)

(21) Appl. No.: 13/216,002

(22) Filed: Aug. 23, 2011

(51) Int. Cl. H04W 4/00

(52) U.S. Cl. 455/41.2

(57) ABSTRACT

A first mobile computing device comprising a first mobile computing device touch screen, one or more files, one or more sensors adapted to detect a first location of a second mobile computing device relative to the first mobile computing device upon the second mobile computing device being located proximally to the one or more sensors, and one or more first mobile computing device applications, wherein, the one or more first mobile computing device applications, communicatively receives the first location of the second mobile computing device from the one or more sensors, and communicatively transfers the one or more files to the second mobile computing device upon at least one of, touching the first mobile computing device touch screen with a touching device and sliding the touching device towards the first location of the second mobile computing device, and moving the second mobile computing device from the first location to a second location.

### BACKGROUND OF THE INVENTION

1. Field of the Invention

This invention is related to the transfer of data between mobile computing devices. Specifically, but not intended to limit the invention, embodiments of the invention are involved with detecting a location of a second mobile computing device relative to a first mobile computing device and transferring data between the mobile computing devices.

2. Relevant Background

It is often necessary or desirable to transfer data from one mobile computing device to another mobile computing device. Current methods and mechanisms adapted to transfer data between mobile computing devices are inadequate as they may be slow or may require the devices to touch each other, which is not always desirable or possible, due to protective cases and wraps adapted to fit on the mobile computing devices, or otherwise.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One embodiment of the invention comprises a first mobile computing device comprising a first mobile computing device touch screen, one or more files, and one or more sensors adapted to detect a first location of a second mobile computing device relative to the first mobile computing device—upon the second mobile computing device being located proximally to the one or more sensors. The first mobile computing device further comprises one or more first mobile computing device applications, wherein, the one or more first mobile computing device applications communicatively receives the first location of the second mobile computing device from the one or more sensors, and communicatively transfers the one or more files to the second mobile computing device. The one or more files are transferred to the second mobile computing device upon at least one of, (i) touching the first mobile computing device touch screen with a touching device and sliding the touching device towards the first location of the second mobile computing device, and (ii) moving the second mobile computing device from the first location to a second location.

Another embodiment of the invention comprises a method of transferring data from a first mobile computing device to a second mobile computing device. One method comprising placing the second mobile computing device proximally to the first mobile computing device and detecting a first location of the second mobile computing device relative to the first mobile computing device. The method further comprises selecting data on the first mobile computing device and communicatively transferring the data to the second mobile computing device. The data is communicatively transferred by one of (i) touching a first mobile computing device touch screen with a touching device and moving the touching device towards the first location of the second mobile computing device, and (ii) moving the second mobile computing device from the first location to the second location.

Yet another embodiment of the invention comprises a data transfer system. One data transfer system comprises means for one or more first mobile computing device sensors to detect a presence of one or more second mobile computing device sensors. The data transfer system further comprises means for selecting one or more first mobile computing device data files and means for initiating a transfer of the one or more first mobile computing device data files from a first mobile computing device to a network device. The data transfer system may further comprise means for transferring the one or more data files from the network device to a second mobile computing device.

And yet another embodiment of the invention comprises a non-transitory, tangible computer readable storage medium, encoded with processor readable instructions to perform a method of transferring data between mobile computing devices. One embodiment comprises launching an application on each of the mobile computing devices, the application adapted to transfer data between the mobile computing devices. Additionally, the method comprises using sensors on the mobile computing devices to detect a location of the other of the mobile computing devices, selecting the data to transfer on at least one of the mobile computing devices, sliding a finger across a touch screen on one of the mobile computing devices towards the other of the mobile computing devices, removing the finger from the touch screen, and communicatively transferring the data to the other of the mobile computing device.

### BRIEF DESCRIPTION ON THE DRAWINGS

FIG. 1 illustrates a block diagram depicting physical components of a mobile computing device;

FIG. 2 illustrates various first locations of a second mobile computing device relative to a first mobile computing device;

FIG. 3 illustrates moving a second mobile computing device from a first location to a second location;

FIG. 4 illustrates the placement of sensors in a first and a second mobile computing device;

FIG. 5 illustrates the placement of sensors in a first and a second mobile computing device;

FIG. 6 depicts a method that may be carried out in conjunction with the embodiments described herein;

FIG. 7 illustrates a data transfer system comprising a first mobile computing device, second mobile computing device, and a network device.

### DETAILED DESCRIPTION

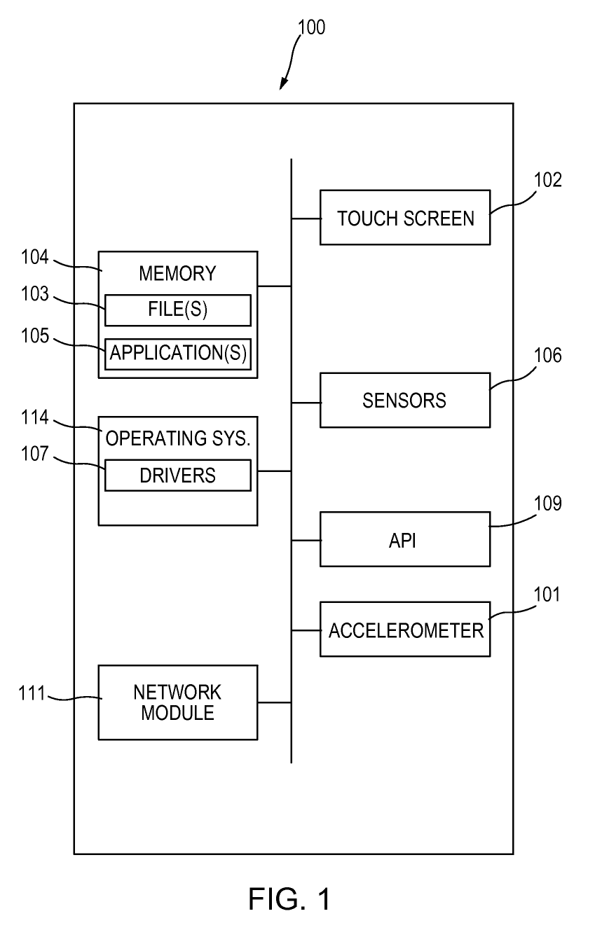

Looking first at FIG. 1, seen is a first mobile computing device 100 comprising a first mobile computing device touch screen 102, memory 104, and one or more sensors 106. The memory 104 may comprise one or more files 103 and one or more applications 105. It is contemplated that the one or more files 103 may comprise any data that a user of the mobile computing device 100 wishes to share with a second mobile computing device. For example, the one or more files 103 may comprise digital files such as, but not limited to contact information, documents, executable files, and/or audio/video content.

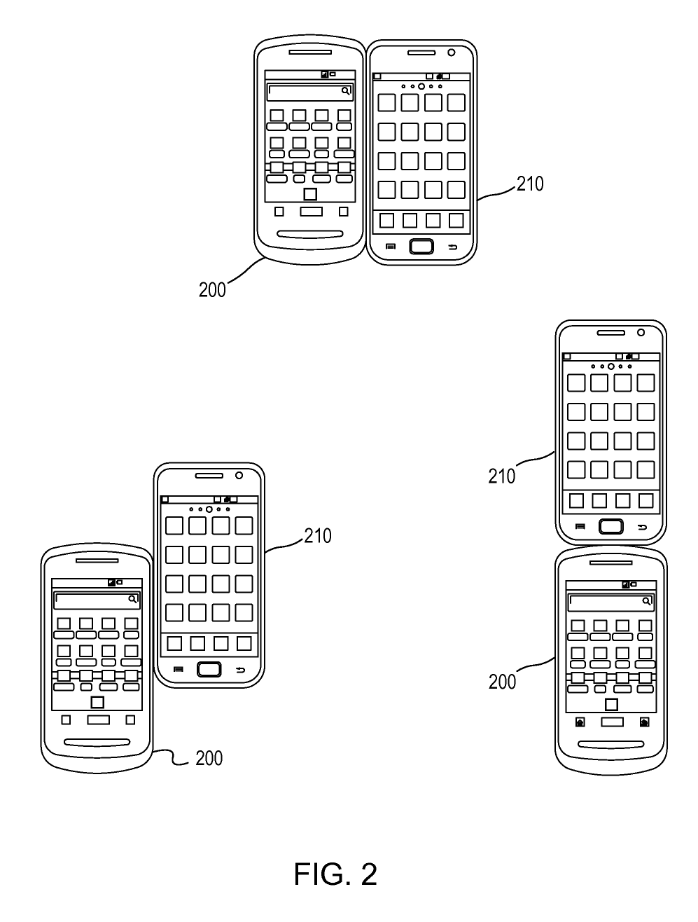

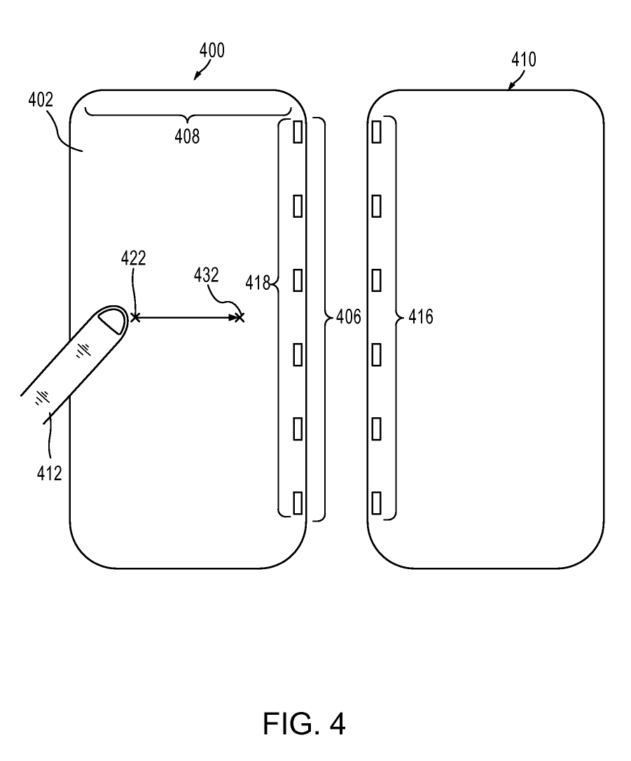

The one or more sensors 106 are adapted to detect a first location of a second mobile computing device relative to the position of the first mobile computing device 100. For example, seen in FIG. 2 are various first locations of a second mobile computing device 210 relative to the position of the first mobile computing device 200. The first location of the second mobile computing device 210 may be detected upon the second mobile computing device 210 being located proximally to the one or more sensors 106. For example, seen in FIG. 4 are the one or more sensors 406 of the first mobile computing device 406. In such an embodiment, the one or more sensors 406 may detect the presence of the second mobile computing device 410 upon the second mobile computing device 410 being placed proximally to the one or more sensors 406. It is also contemplated that the one or more sensors 406 may comprise one or more first mobile computing device sensors and the one or more first mobile computing device sensors may detect the location of the second mobile computing device 410 upon one or more second mobile computing device sensors 416 being located proximally to the one or more first mobile computing device sensors. Throughout the specification the one or more first mobile computing device sensors and one or more second mobile computing device sensors 416 may be referred to as one or more sensors 406.

The first location of the second mobile computing device 410 relative to the first mobile computing device 400 may be determined based on which of the one or more sensors 406 on the first mobile computing device 400 detect the second mobile computing device 410. For example, it is contemplated that at least a portion of the one or more sensors 406 may be located in an area of the mobile computing device 400 such as, but not limited to a top portion 408 of the mobile computing device 400. In such an embodiment, if the one or more sensors 406 located in the top portion 408 of the mobile computing device 400 detect the presence of the second mobile computing device 410 and the one or more sensors 406 located in a right-side portion 418 of the first mobile computing device 400 fail to detect the second mobile computing device 410, the second mobile computing device 400 may be determined to be proximally to the top portion 408 of the mobile computing device 400. It is also contemplated that references throughout the specification to the first mobile computing device 100 may also relate to the second mobile computing device 310.

Returning now to FIG. 1, it is contemplated that the one or more sensors 106 may comprise pressure sensors, magnetic sensors, and/or any other sensor-type adapted to detect the presence of another device. The one or more sensors 106 of the first mobile computing device 100 may be adapted to detect the another device when the another device comprises one or more sensors 106 and the one or more sensors 106 of the another device are located proximally to the one or more sensors 106 of the first mobile computing device 100. The one or more sensors 106 are adapted to communicatively provide data to the one or more applications 105. For example, one or more drivers 107 my operate in the background of an operating system 114 and may adapted to receive signals from the one or more sensors 106 and determine whether the one or more sensors 106 detect the presence of the second mobile computing device 410 as seen in FIG. 4. The drivers 114 may communicate with an application programming interface, or API 109, adapted to communicate with the one or more applications 105. The one or more applications 105 may therefore communicatively receive the first location of the second mobile computing device 410 from the one or more sensors 106. The one or more applications 105 may also be referred to as one or more first mobile computing device applications. Although the API 109 and drivers 107 are seen as separate from the memory 104, it is contemplated that in one embodiment, they may at least partially located in the memory 104. It is contemplated that the one or more first mobile computing device sensors seen in FIG. 4 may only provide a signal to the drivers 107 of FIG. 1 that they detect the presence of the second mobile computing device 410 when one or more second mobile computing device sensors 416 are located proximally to the one or more first mobile computing device sensors.

The one or more applications 105 are further adapted to communicatively transfer the one or more files 103 to the second mobile computing device 410. For example, the one or more applications 105 may comprise a user interface adapted to select the one or more files 103 to transfer. The transfer of the one or more files 103 to the second mobile computing device 410 may occur upon touching the touch screen 102 of the first mobile computing device 100 with a touching device and sliding the touching device towards the first location of the second mobile computing device 410.

For example, seen in FIG. 4 is a touching device 412 comprising a finger. Upon selecting the files to transfer, a person may place his or her finger on the touch screen 402 of the first mobile computing device 400 and slide the finger towards the location of the second mobile computing device 410. The touch screen 402 may inform the API 109 of the direction of movement of the finger and the API 109 may determine whether the direction of movement of the finger is in the direction of the first location of the second mobile computing device 410. For example, the API 109 may calculate a first touching location 422 where the touching device 412 first touched the touch screen 402. The API 109 may also calculate a second touching location 432 comprising where the touching device 412 last touched the touch screen 402. Instead of sliding the touching device from the first touching location 422 to the second touching location 432, it is contemplated that the touching device 412 may also tap the touch screen 402 at the first touching location 422 and the second touching location 432. The API 109 may determine whether the second touching location 432 is closer to the one or more sensors 406 detecting the first location of the second mobile computing device 410 than the first touching location 422; and, if so, the application 105 may transfer the one or more files 103 to the second mobile computing device 410. If not, then the application 105 may inform the user that no device is located in that direction and may not transfer the files. It is contemplated that the application 105 may perform the calculation instead of the API 109. Furthermore, the second mobile computing device 410 may be substantially similar to the first mobile computing device 100 and an application 105 running on the second mobile computing device 410 may be adapted to place transferred files a specific location on the second mobile computing device 410. At least a portion of the files may be either copied to the second mobile computing device 410 and/or cut from the first mobile computing device 400 and pasted to the second mobile computing device 410.

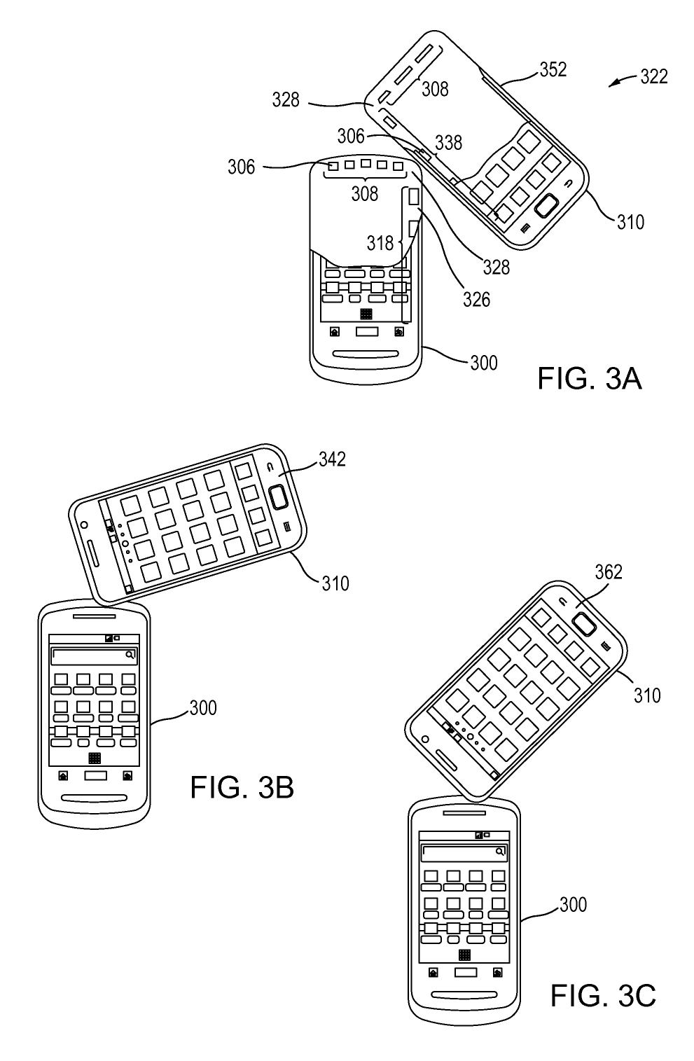

Turning to FIGS. 3A-3C, in one embodiment, any of the one or more files 103 selected for transfer may be transferred from the first mobile computing device 300 to the second mobile computing device 310 moving the second mobile computing device 310 from the first location 352 to a second location 362. Seen in FIG. 3A is a second mobile computing device 310 in one first location 352. It is contemplated that in such an embodiment, the first mobile computing device 300 may comprise one or more sensors 306 in a corner portion 328 of the first mobile computing device 300. However, the one or more sensors 306 may also be located in the top portion 308, right-side portion 318, or any other portion of the first mobile computing device 300, and may be located near a housing 326 of the first mobile computing device 300. The second mobile computing device 310 may likewise comprise a housing 326. In one embodiment, at least one of the one or more sensors 306 on the second mobile computing device 322 may be located in a center portion of a left-side section 338. However, at least a portion of the one or more sensors 306 may also be located in the corner portion 328, top portion 308, or any other portion of the second mobile computing device 310. Other first positions 352 are contemplated.

Upon placing the second mobile computing device 310 in the first position 352, the second mobile computing device 310 may be moved to the second position 362, as seen in FIG. 3C. For example, the one or more sensors 306 in the first mobile computing device 300 and the one or more sensors 306 in the second mobile computing device 310 may detect that the second mobile computing device 310 has moved from the first positions 352 through a temporary position 342 seen in FIG. 3B and to the second position 362. Upon reaching the second position 362 the selected files may be transferred from the first mobile computing device 300 to the second mobile computing device 310. Alternatively, or additionally, files selected on the second mobile computing device 310 may be transferred to the first mobile computing device 300.

Furthermore, as seen in FIG. 1, the first mobile computing device 100 may also comprise an accelerometer 101 and data from the accelerometer 101 may be used to determine when the second position 362 is reached. The accelerometer may be adapted to communicate with a driver 107, which adapted to communicate with the API 109. The API 109 may then communicate with the one or more applications 105. Therefore, upon the accelerometer 101 determining that the second location 362 has been reached, and communicatively informing the one or more applications 103 that the second location 362 has been reached, the one or more applications may initiate transfer of the selected one or more files 103 to the other mobile computing device. As seen, moving the second mobile computing device 310 from the first location 352 to the second location 362 may comprise pivoting at least a section of the second mobile computing device 310 towards the first mobile computing device 300. For example, the top portion 308 of the second mobile computing device 310 may be pivoted towards the first mobile computing device 300, with the second mobile computing device 310 being pivoted, for example, about at least one of the second mobile computing device corner portion 328, or potentially, a center portion of the second mobile computing left side section 338. Other locations on the second mobile computing device 310 to pivot around are also contemplated.

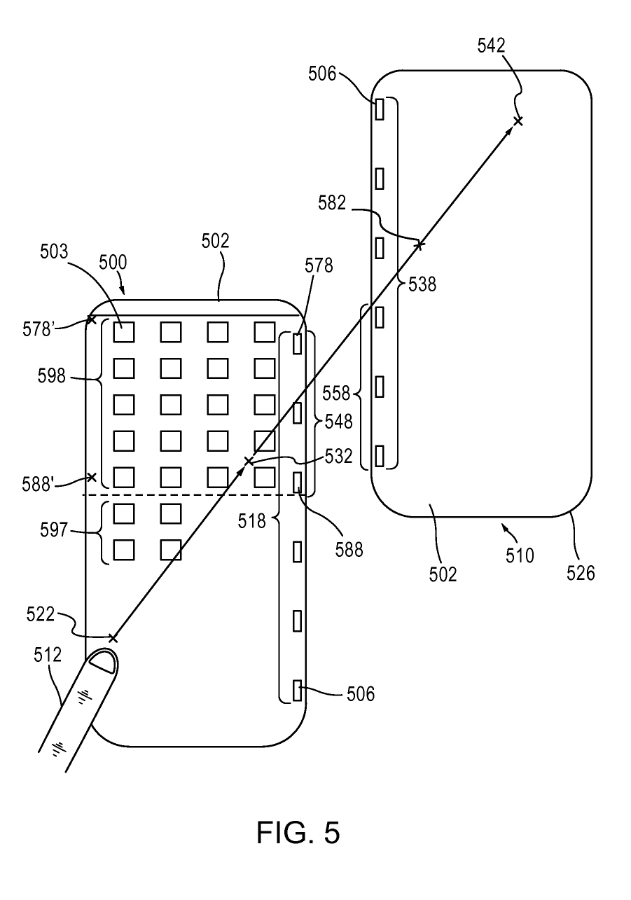

Turning now to FIG. 5, seen is a first mobile computing device 500 and a second mobile computing device 510. Each of the mobile computing devices 500, 510 comprises a touch screen 502. As seen, one or more sensors 506 may be located in a right-side portion 518 of the first mobile computing device 500. At least a portion of the second mobile computing device 510 may be placed proximally to an upper right portion 548 of the right-side portion 518 of the one or more sensors 506. Similarly, only a lower left portion 558 of a left-side portion 538 of the one or more sensors 506 on the second mobile computing device 510 is located proximally to the first mobile computing device 500. In such an embodiment, and in other embodiments, transferring one or more selected files to the second mobile computing device 510 may comprise touching the touch screen 502 on the first mobile computing 500 with the touching device 512 at the first touching location 522 and slide the touching device 512 towards a second touching location 532. In order to transfer any selected files, the second touching location 532 should be closer to the first location of the second mobile computing device 510, than the first touching location 522.

In one embodiment, the touching device 512 may continue past the second touching location 532 to a third touching location 572, which may be located on the touch screen 502 of the second mobile computing device 510. It is contemplated that such an embodiment may comprise a bi-directional embodiment. Placement of the mobile computing devices 500, 510 in other locations such as, but not limited the locations seen in FIG. 2, may also comprise a bi-directional embodiment. In one bi-directional embodiment, the one or more sensors 506 on each of the first and second mobile computing devices 500, 510 may detect the location of the one or more sensors 506 on the other of the first and second mobile computing devices 500,510. Such a detection may launch the one or more applications 103 on each device 500, 510. Upon launch of the applications 103, it is the direction of the swipe which may determine which of the mobile computing devices 500, 510 is the sending and the receiving mobile computing device 500, 510 respectively. For example, if one or more applications 105 on the second mobile computing device 510 determines that the touching device 512 touches the second mobile computing device at the third touching location 572 and slides the touching device 512 to the fourth touching location 582, with the fourth touching location 582 being nearer the location of the first mobile computing device 500, the one or more application 105 may determine that the second mobile computing device 510 is the sending device and may send any of the one or more files that are pre-approved for sharing may be sent to the first mobile computing device 500. The second mobile computing device 510 may also be the receiving device if the one or more applications 105 first detects the fourth touching location 582 before detecting the third touching location 572. Similar detection of touching locations to determine whether the device is a receiving or sending device may occur on the first mobile computing device 500. It is contemplated that the third touching location 572 may be in an upper right portion of the touch screen 502 of the second mobile computing device 510 relative to the location of the fourth touching location 582. Also, the fourth touching location 582 may be located proximally to the housing 526 on the second mobile computing device 510.

Returning again to FIG. 1, as seen, the first mobile computing device 100 may also comprise a network module 111. One network module 111 may comprise a communication device adapted to communicate with the second mobile computing device 510. The network module 111 may be adapted to communicate over a plurality of networks and protocols. For example, the network module 111 may be adapted to communicate with the second mobile computing device 510 via a Bluetooth connection and may be adapted to communicate with a wireless network via a cellular connection.

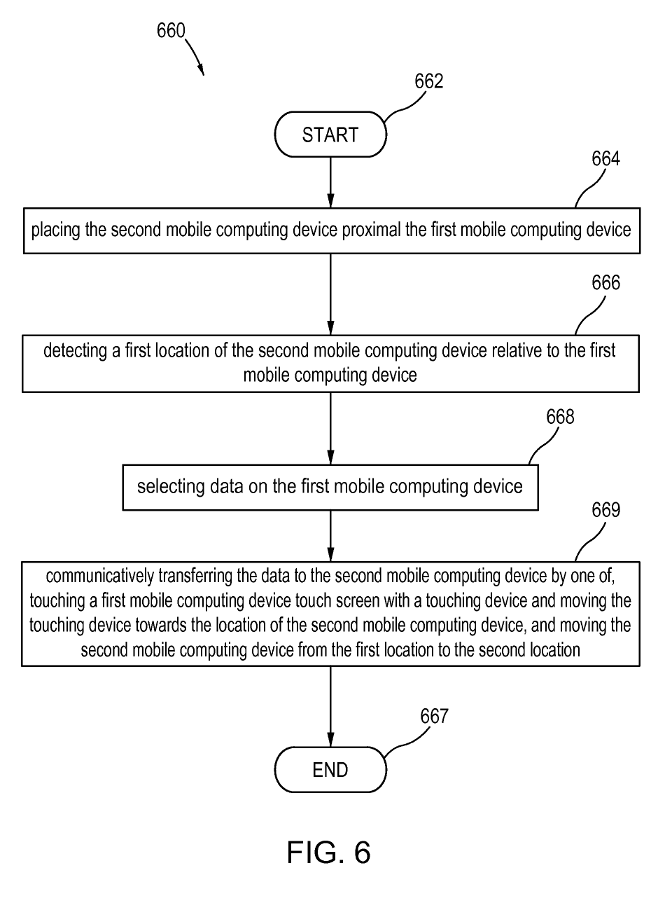

Turning now to FIG. 6, and in light of FIGS. 1-5, seen is a method 660 of transferring data from a first mobile computing device 400 to a second mobile computing device 410. One method starts at 662 and at 664 comprises placing the second mobile computing device 410 proximally to the first mobile computing device 400. At 666 the method 660 comprises detecting a first location of the second mobile computing device 410 relative to the first mobile computing device 400. FIG. 2 shows various first locations of the second mobile computing device 210 relative to the first mobile computing device 200. The one or more sensors 406 on the first mobile computing device 400 may detect where the second mobile computing device 410 is located relative to the first mobile computing device 400. At 668, the method 660 comprises selecting data on the first mobile computing device 400.

Selecting data may comprise pre-configuring data to be shared through one or more applications 105, or may comprise identifying through the one or more applications 105 one or more files 103 to share. For example, files to share may be dragged from a file management system such as, but not limited to, Windows Explorer, to the one or more applications 105. Alternatively, in one embodiment, the selections of the one or more files 103 to share may comprise determining a first sensor 578 of the one or more sensors 506 and a second sensor 588 of the one or more sensors. The first sensor 578 may comprise a first of a portion of sensors such as, but not limited to, the upper right portion 548 or sensors that detect the presence of the second mobile computing device 510, while the second sensor 588 may comprise the last of the one or more sensors 506 that may detect the second mobile computing device 510. Upon obtaining the first and second sensors 578, 588, selecting the one or more files 103 may comprise selecting the one or more files 503 displayed between the first and second sensors 578, 588. For example, seen in FIG. 5 is selected data 598. In one embodiment the selected data 598 is obtained by determining co-ordinates on the touch screen 502 for each of the first and second sensors 578, 588. Then, a corresponding co-ordinate is determined an opposing side of the mobile computing device tough-screen 578′, 588′, and a virtual line is established between the sensor co-ordinate and the corresponding co-ordinate, and the one or more files 503 between each of these virtual lines comprise the selected files 598. Any of the one or more files 503 outside of these lines comprise unselected files 597. The unselected files 597 may not be transferred. The virtual lines may be horizontal or vertical lines, depending on the first location of the second mobile computing device 510.

Upon selecting the one or more files 503, at 669, the one or more files 503 are communicatively transferred to the second mobile computing device 510. For example, the touch screen 502 of the first mobile computing device 500 may be touched with the touching device 512 and the touching device 512 may be moved towards the location of the second mobile computing device 510. Also, the data may be transferred upon moving the second mobile computing device 510 from a first location, such as, but not limited to, the first location 352 seen in FIG. 3A, to the second location, such as, but not limited to, the second location 362 seen in FIG. 3C. The method 660 ends at 667.

Methods 660 may also comprise additional steps or variations on the steps seen in FIG. 6. For example selecting data on the first mobile computing device 100 may comprise displaying the one or more files 103 and at least one of, drawing at least one circle around at least a portion of the one or more files 103 in order to select the files to transfer, and tapping at least a portion of the one or more files 103 in order to select the files to transfer. Selecting data on the first mobile computing device 100 may also comprise selecting all transferrable data on the first mobile computing device 100. For example, the one or more applications 105 may enable a user to transfer all transferrable data on the first mobile computing device 500 to the second mobile computing device 502. In one embodiment, this may be done by placing more than one touching devices 512 on the first mobile computing device touch screen 502, and swiping the more than one touching devices 512 towards the second mobile computing device 510. Placing more than one touching devices 512 on the first mobile computing device touch screen 502 may comprise placing 4 fingers on the touch screen 502—for example, in for corner portions 328 of the touch screen, without removing any of the other of the four touching device 512 from the touch screen; the four fingers may then be swiped towards the second mobile computing device 510. Additionally, methods 660 may comprise touching a touch screen 520 of a second mobile computing device 510 with a touching device 512 and moving the touching device 512 towards the first mobile computing device 500. Methods 660 may also comprise providing data from the plurality of sensors 106 on the first mobile computing device 100 to the one or more device drivers 107, and using the data to determine the location of the second mobile computing device 510.

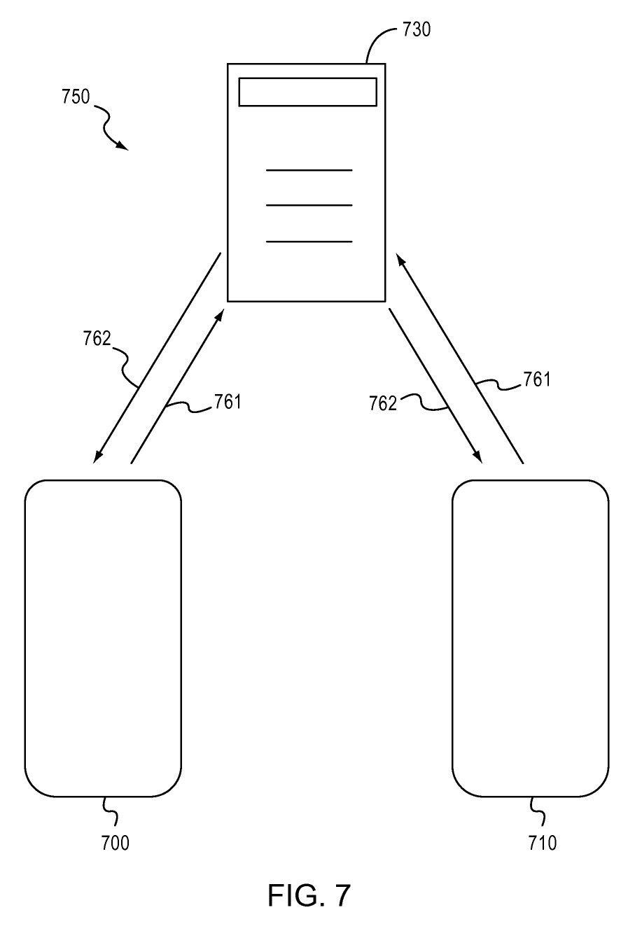

Turning now to FIG. 7, seen is a data transfer system 750. One data transfer system 750 comprises the first mobile computing device 700, second mobile computing device 710, and a network device 730. In such an embodiment, the one or more data files 103 may be transferred 761 to the network device 730 from the first mobile computing device 100. The network device 730 may then send 762 the one or more files 103 to the second mobile computing device 710. The embodiments described with reference to FIGS. 1-6 may be used in conjunction with the FIG. 7 embodiment. For example, one or more sensors 506 on the first mobile computing device 500 may detect a presence of one or more sensors 506 on the second mobile computing 510. Similarly, one or more files 503 on the first mobile computing device 500 may be selected and the one or more files 503 may be transferred from the first mobile computing device 500 to the network device 730 by utilizing the touch screen 502 or moving the second mobile computing device 310 from the first location 352 to a second location 362. The network device 730 may then transfer the one or more data files from the network device 730 to the second mobile computing device 710. In one embodiment, selecting one or more first mobile computing device data files may comprise determining a co-ordinate of a first sensor 578 of the one or more sensors 506 and a second sensor 588 of the one or more sensors 506. The transfer 761 and sending 762 of the files may also occur from the second mobile computing device 710 to the first mobile computing device 700 through the network device 730.

It is also contemplated that one embodiment of the invention may comprise a non-transitory, tangible computer readable storage medium, encoded with processor readable instructions to perform a method of transferring data between mobile computing devices. For example, one such method may comprise launching one of the one or more applications 105 on the first mobile computing device 500 and second mobile computing device 510. In one embodiment, the applications 105 on each device are adapted to transfer data between the devices. The method performed by the non-transitory, tangible computer readable storage medium may further comprise using the one or more sensors 506 on the mobile computing devices 500, 510 to detect a location of the other of the mobile computing devices 500, 510. Furthermore, the method performed by the tangible computer readable storage medium may further comprise selecting the data to transfer on at least one of the mobile computing devices. For example, one or more of the one or more files 503 may be selected for transfer from the first mobile computing device 500 to the second mobile computing device 510 or vice versa. The method performed by the processor-readable instructions on the tangible computer readable storage medium may further comprise communicatively transferring the data to the other of the mobile computing device 500, 510 by sliding a finger across a touch screen 502 on one of the mobile computing devices 500, 510 towards the other of the mobile computing devices 500, 510 and removing the finger from the touch screen 502.

In one embodiment, launching an application 105 on each of the mobile computing devices 500, 510 may occur automatically upon the device drivers 107, or other service layer entity, receiving information from the one or more sensors 106 that the sensors 106 have detected a location of other of the mobile computing devices 500, 510. In launching an application 103 on each of the mobile computing devices 500, 510, the tangible computer readable storage medium may display the one or more data files 103. Additionally, the one or more sensors 506 on each of the mobile computing devices 500, 510 may detect a location of the other of the mobile computing devices 500, 510 by determining which of one or more sensors 506 detect the location of the other of the mobile computing devices 500, 510 and determining whether any of the one or more sensors 506 do not detect the location of the other of the mobile computing devices 500, 510. For example, the tangible computer readable storage medium may determine on the first mobile computing device 500 of FIG. 5 that the one or more sensors 506 not comprising the upper right portion 548 of the right-side portion 518 of the one or more sensors 506 do not detect the location of the second mobile computing device 510. In such an embodiment, selecting the data to transfer on the first mobile computing device 500 comprises, matching a location of the first sensor 578 with a first touch screen co-ordinate and matching a location of a last of the sensors to detect the location of the other of the mobile computing devices such as the second sensor 588 with a second touch screen co-ordinate. Selected data 598 on the touch screen between the first touch screen co-ordinate and the second touch screen so-ordinate may then be transferred.

In conclusion, embodiments of the present invention provides the ability to transfer data between mobile computing devices without the devices actually touching. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A first mobile computing device comprising,
a first mobile computing device touch screen;
one or more files;
one or more sensors adapted to detect a first location of a second mobile computing device relative to the first mobile computing device upon the second mobile computing device being located proximally to the one or more sensors, and
one or more first mobile computing device applications, wherein, the one or more first mobile computing device applications,
communicatively receives the first location of the second mobile computing device from the one or more sensors, and
communicatively transfers the one or more files to the second mobile computing device upon at least one of,
touching the first mobile computing device touch screen with a touching device and sliding the touching device towards the first location of the second mobile computing device, and
moving the second mobile computing device from the first location to a second location.

2. The first mobile computing device of claim 1 further comprising,
one or more sensor drivers adapted to communicate with the one or more sensors; and
an application programming interface adapted to communicate with the one or more sensor drivers and the one or more first mobile computing device applications.

3. The first mobile computing device of claim 1 further comprising,
a housing having at least one of,
one or more side portions, and
at least one first mobile computing device corner; and wherein
the one or more sensors comprise one or more first mobile computing device sensors, the one or more first mobile computing device sensors being located proximally to at least one of,
at least one section of the one or more side portions, and
the at least one first mobile computing device corner;
the second mobile computing device comprises one or more second mobile computing device sensors; and
the one or more first mobile computing device sensors detect the presence of the second mobile computing device upon the one or more second mobile computing device sensors being located proximally to the one or more first mobile computing device sensors.

4. The mobile computing device of claim 3 wherein,
the one or more side portions at least comprises a right side portion;
the second mobile computing device comprises a left side portion;
the first location of the second mobile computing device comprises the left side portion being located proximally to the right side portion; and
touching the first mobile computing device touch screen with a touching device and sliding the touching device towards the first location comprises touching the first mobile computing device touch screen with at least one finger and sliding the finger towards the right side portion.

5. The first mobile computing device of claim 1 wherein,
the second mobile computing device comprises
an accelerometer one or more inputs and outputs, and
at least one of
a second mobile computing device corner, and
a second mobile computing device sidewall center section;
the one or more second mobile computing device sensors are located proximally to the at least one of,
the second mobile computing device corner, and
the second mobile computing device sidewall center section; and
moving the second mobile computing device from the first location to a second location comprises pivoting at least a section of the second mobile computing device towards the first mobile computing device about the at least one of
the second mobile computing device corner, and
the second mobile computing device sidewall center section; and
the one or more inputs received by the accelerometer upon pivoting at least a section of the second mobile computing device initiates transfer of the one or more files to the second mobile computing device.

6. The mobile computing device of claim 1 wherein,
the second mobile computing device further comprises a second mobile computing device touch screen and one or more second mobile computing device applications; and
transfers the one or more files to the second mobile computing device upon touching the first mobile computing touch screen with a touching device and sliding the touching device towards the first location of the second mobile computing device comprises,
reaching a housing of the first mobile computing device, and
continuing to slide the touching device along the second mobile computing device touch screen away from the housing of the first mobile computing device in a substantially similar direction as sliding the touching device towards the first location of the second mobile computing device.

7. The mobile computing device of claim 1 further comprising, a communication device adapted to communicate with the second mobile computing device.

8. The mobile computing device of claim 1 wherein, transfers the one or more files to the second mobile computing device upon at least one of, touching the first mobile computing device touch screen with a touching device and sliding the touching device towards the first location of the second mobile computing device comprises,
calculating a first touch position on the first mobile computing device touch screen;
calculating a second touch position on the first mobile computing device touch screen; and
transferring the one or more files when the second touch position is closer to the first location than the first touch position.

9. A method of transferring data from a first mobile computing device to a second mobile computing device comprising,
placing the second mobile computing device proximally to the first mobile computing device;
detecting a first location of the second mobile computing device relative to the first mobile computing device;
selecting data on the first mobile computing device; and
communicatively transferring the data to the second mobile computing device by one of,
touching a first mobile computing device touch screen with a touching device and moving the touching device towards the first location of the second mobile computing device, and
moving the second mobile computing device from the first location to the second location.

10. The method of claim 9 wherein,
selecting data on the first mobile computing device comprises,
displaying one or more files; and
at least one of,
drawing at least one circle around at least a portion of the one or more files, and
tapping at least a portion of the one or more files; and
the touching device comprises a finger.

11. The method of claim 9 further comprising,
touching a second mobile computing device touch screen with a touching device and moving the touching device towards the location of the first mobile computing device; and wherein,
the touching a second mobile computing device touch screen with a touching device and moving the touching device towards the location of the first mobile computing device, and the touching a first mobile computing device touch screen with a touching device and moving the touching device towards the location of the second mobile computing device comprises,
sliding a finger bi-directionally on the first mobile computing device touch screen and the second mobile computing device touch screen.

12. The method of claim 11 wherein,
placing the second mobile computing device proximally to the first mobile computing device comprises,
placing a lower left portion of the second mobile computing device proximally to an upper right portion of the first mobile computing device; and
sliding a finger bi-directionally on the first mobile computing device touch screen comprises,
sliding a finger from a lower left portion of the first mobile computing device touch screen through an upper right portion of the first mobile computing device touch screen and a lower left portion of the second mobile computing device touch screen to an upper right portion of the second mobile computing device touch screen.

13. The method of claim 9 wherein, detecting the first location of the second mobile computing device comprises,
providing data from a plurality of sensors on the first mobile computing device to one or more device drivers; and
using the data to determine the location of the second mobile computing device.

14. The method of claim 9 wherein, moving the touching device towards the location of second mobile computing device comprises sliding the touching device along the touch screen.

15. The method of claim 9 wherein selecting data on the first mobile computing device comprises selecting all transferrable data on the first mobile computing device.

16. The method of claim 15 wherein,
selecting all transferrable data on the first mobile computing device comprises,
touching a first mobile computing device touch screen at a first location with the touching device, the touching device comprising a first touching device, and
touching the first mobile computing device touch screen at at least one second location with at least one second touching device prior to removing the first touching device from the first location; and
transferring the data to the second mobile computing device comprises substantially simultaneously moving the first touching device and the at least one second touching device towards the second mobile computing device.

17. A data transfer system comprising,
means for one or more first mobile computing device sensors to detect a presence of one or more second mobile computing device sensors;
means for selecting one or more first mobile computing device data files;
means for initiating a transfer of the one or more first mobile computing device data files from a first mobile computing device to a network device; and
means for transferring the one or more data files from the network device to a second mobile computing device.

18. The data transfer system of claim 17 wherein, the means for initiating a transfer of the one or more first mobile computing device data files from a first mobile computing device to a network device comprises one of,
means for utilizing a touch screen to initiate the transfer of the one or more first mobile computing device data files; and
means for moving the second mobile computing device from a first location to a second location to initiate the transfer of the one or more first mobile computing device data files.

19. The data transfer system of claim 17 wherein, the means for selecting one or more first mobile computing device data files comprises,
means for determining a co-ordinate of,
a first of the one or more sensors, and
a second of the one or more sensors; and
means for selecting the one or more data files between the first of the one or more sensors and the second of the one or more sensors.

20. A non-transitory, tangible computer readable storage medium, encoded with processor readable instructions to perform a method of transferring data between mobile computing devices comprising,
launching an application on each of the mobile computing devices, the application adapted to transfer data between the mobile computing devices;
using sensors on the mobile computing devices to detect a location of the other of the mobile computing devices;
selecting the data to transfer on at least one of the mobile computing devices;
sliding a finger across a touch screen on one of the mobile computing devices towards the other of the mobile computing devices;
removing the finger from the touch screen; and
communicatively transferring the data to the other of the mobile computing device.

21. The non-transitory, tangible computer readable storage medium of claim 21 wherein, the launching an application on each of the mobile computing devices adapted to transfer data between mobile computing devices occurs after sensors on the mobile computing devices detect the location of other of the mobile computing devices.

22. The non-transitory, tangible computer readable storage medium of claim 22 wherein,
the launching an application adapted to transfer data between mobile computing devices is performed by a service layer of the mobile computing devices; and
the service layer of the mobile computing devices,
comprises a background service, and
communicates with one or more sensor drivers.

23. The non-transitory, tangible computer readable storage medium of claim 21 wherein,
the launching an application on each of the mobile computing devices comprises displaying one or more data files;
using sensors on each of the mobile computing devices to detect a location of the other of the mobile computing devices comprises,
determining which of one or more sensors detect the location of the other of the mobile computing devices, and
determining whether any of the one or more sensors do not detect the location of the other of the mobile computing devices; and
selecting the data to transfer on at least one of the mobile computing devices comprises,
matching a location of a first of the sensors to detect the location of the other of the mobile computing devices with a first touch screen co-ordinate,
matching a location of a last of the sensors to detect the location of the other of the mobile computing devices with a second touch screen co-ordinate, and
selecting the data on the touch screen between the first touch screen co-ordinate and the second touch screen so-ordinate.

24. The non-transitory, tangible computer readable storage medium of claim 24 wherein, selecting the data on the touch screen between the first touch screen co-ordinate and the second touch screen so-ordinate further comprises,
extending one of a virtual horizontal line and a virtual vertical line from each of the first touch screen co-ordinate and the second touch screen co-ordinate; and
selecting the data on the touch screen between each of the one of virtual vertical lines and virtual horizontal lines.

25. The non-transitory, tangible computer readable storage medium of claim 25 further comprising,
pre-configuring at least a portion of the data to not be shared; and
moving the pre-configured data to outside of between the one of vertical and horizontal lines.
